(19) United States
(12) Patent Application Publication
(10) Pub. No.: US 2012/0074130 A1
(43) Pub. Date: Mar. 29, 2012

(54) MAGNETOCALORIC HEAT APPLIANCE COMPRISING A MAGNETIC FIELD GENERATOR

(75) Inventors: Christian Muller, Strasbourg (FR); Jean-Claude Heitzler, Horbourg-Wihr (FR)

(73) Assignee: COOLTECH APPLICATIONS, Holtzheim (FR)

(21) Appl. No.: 13/375,863

(22) PCT Filed: Jun. 15, 2010
(86) PCT No.: PCT/IB2010/001441

§ 371 Date: Dec. 2, 2011

(30) Foreign Application Priority Data
Jun. 18, 2009 (FR) 09/54113

(51) Int. Cl. H05B 1/00

(52) U.S. Cl. 219/520

(57) ABSTRACT

A magnetocaloric heat appliance which comprises at least one magnetocaloric element through which a heat transfer fluid flows and a magnetic activation and deactivation mechanism for the magnetocaloric element which comprises a magnetic field generator (1) provided with at least one magnetic assembly (2) arranged so as to create a magnetic field in a gap (4). The magnetocaloric element (13) is in a relative movement to the magnetic field generator (1). This appliance is characterized in that the magnetic assembly (2) is arranged in a casing (11) which comprises at least one opening (5) in communication with the gap (4) and the magnetic field generator (1) also comprises at least one canalising mechanism (6) connected with the casing (11) and able to capture and canalise the magnetic field leakages that occur outside of the magnetic field generator (1), in the region close to the opening (5).

### TECHNICAL SCOPE

The present invention relates to a magnetocaloric heat appliance comprising at least one magnetocaloric element through which a heat transfer fluid flows and a means of magnetic activation and deactivation of said magnetocaloric element comprising a magnetic field generator provided with at least one magnetic assembly arranged so as to create a magnetic field in a gap, said magnetocaloric element being in a relative movement with respect to said magnetic field generator.

### PRIOR TECHNIQUE

In order to achieve in an economical way a strong magnetic field, of the order of 1.6 teslas, for example, in a restricted space, it is known to realise a magnetic field generator in the form of a magnetic assembly by using for example permanent magnets. In many applications, and in particular in the area of the magnetocaloric heat appliances, this restricted space in which a strong magnetic field is to be created must be open towards the outside in order to allow the introduction of a device to magnetize and demagnetize.

But, for appliance safety and efficiency reasons, it is necessary to avoid the propagation of a magnetic leakage field outside of the magnetic field generator.

This is precisely the case in the area of magnetocaloric heat appliances, in which one or several magnetocaloric elements must be allowed to circulate or to move alternately in the gap of the magnetic assembly (or, conversely, the magnetic assembly must be able to move with respect to the fixed magnetocaloric elements) in order to be subjected to a variable magnetic field. Now, the opening of the gap leads to a magnetic field leakage outside of the magnetic assembly, and thus outside of the magnetocaloric heat appliance. The larger the gap, the stronger the magnetic leakage field. Therefore, an undesirable magnetic leakage field remains in the outside environment close to the opening of the gap. The result of this is that the magnetocaloric elements, when they pass through this zone, are subjected to a magnetic leakage field, even if the latter is weak. This leads to the disadvantage that the magnetocaloric elements do not pass from a zero magnetic field to a strong magnetic field when they enter the gap and vice-versa when they exit the gap, as it is desired. But they are subjected to a magnetic leakage field before they enter the gap and when they leave the gap. Now, in this type of appliance, the difference of intensity of the magnetic fields which the magnetocaloric elements are subjected to must be as high as possible. In fact, the power of such an appliance is directly linked to the difference of magnetic intensity the magnetocaloric elements are subjected to. Therefore, the presence of a non-zero leakage field in the zone outside of the gap leads to a less high field difference and thus limits the efficiency of the magnetocaloric cycles and of the heat appliance. For a same magnetic field variation, if the field leakages are not controlled, a magnetic generator requiring more magnets, thus more expansive, must be provided. Conversely, the suppression of the field leakages allows reducing the cost of the magnetic generator.

### DESCRIPTION OF THE INVENTION

The present invention aims to overcome these disadvantages by proposing a magnetocaloric heat appliance comprising an open-type magnetic field generator, that is to say, whose gap is in communication with the outside environment of the magnetic assembly making up said gap, and in which the magnetic leakage field is controlled so as to be negligible or even equal to zero, in order to be able to subject one or several magnetocaloric elements alternately to a high magnetic field in the gap and to a zero magnetic field outside of the gap.

To that purpose, the invention relates to a magnetocaloric heat appliance characterized in that said magnetic assembly is arranged in a casing comprising at least one opening that is in communication with said gap and in that said magnetic field generator also comprises at least one canalising means connected with said casing and able to capture and canalise the magnetic field leakages that appear outside of said magnetic field generator, in the region close to said opening

The canalising means allows redirecting the magnetic field flux towards the casing of the magnetic field generator so that the field is equal to zero in the region close to the opening of the gap, outside of the magnetocaloric heat appliance or of the magnetic field generator. The result of this is that the magnetic field difference inside and outside of the gap of the magnetic assembly applied to a magnetocaloric element is maximized, which allows increasing the magnetocaloric effect and thus the magnetocaloric efficiency of the heat appliance.

Advantageously, the effect of the canalising means adds to that of the casing. The canalising means acts upon the specific external zone close to the gap, so that no magnetic field remains precisely around the opening of the gap.

According to the invention, said magnetocaloric element can circulate alternately towards a first end of said appliance and towards a second end, opposite to the first end, in order to circulate alternately inside and outside of the gap of said magnetic field generator.

It can of course also be envisaged, within the framework of the present invention, to move the magnetic field generator and to keep said magnetocaloric element in a fixed position.

Said canalising means can preferably comprise a part out of a ferromagnetic material arranged around said opening and delimiting a passage opening corresponding to said opening of the gap.

In a first embodiment variant, said canalising means can be mounted on said casing, in direct contact with it.

In a second embodiment variant, said canalising means can be mounted on said casing, at a distance of it, by means of a mounting armature.

Whatever the embodiment, it is advantageous that the cross section of the shape of the passage opening of said canalising means be approximately identical with the cross section or the shape of the device that is to be subjected to the magnetic flux of the gap.

More specifically, said canalising means can have the shape of an approximately rectangular or circular plate provided with said passage opening.

### BRIEF DESCRIPTION OF THE DRAWINGS

The present invention and its advantages will be better revealed in the following description of embodiments given as non limiting examples, in reference to the drawings in appendix, in which:

FIG. 1 is a simplified perspective view of a magnetic field generator integrated in a magnetocaloric heat appliance according to the invention;

FIG. 2 is a partial section view of the magnetic field generator of FIG. 1;

FIG. 3A is a front elevation view of the magnetic field generator of FIG. 1, represented without the means able to canalise the magnetic field leakages and showing the non-canalised magnetic field lines;

FIG. 3B is a side elevation view of the magnetic field generator of FIG. 3A;

FIG. 4A is a front elevation view of the magnetic field generator of FIG. 1 showing the canalised magnetic field lines;

FIG. 4B is a side elevation view of the magnetic field generator of FIG. 4A;

FIG. 5A is a front elevation view of a variant of the magnetic field generator showing the canalised magnetic field lines;

FIG. 5B is a side elevation view of the magnetic field generator of FIG. 5A showing on the left side the non-canalised magnetic field lines and on the right side the canalised magnetic field lines,

FIG. 6 is a schematic view of a magnetocaloric element,

FIG. 7A is a simplified front elevation view of a magnetocaloric heat appliance comprising a magnetic field generator provided with one single canalising means,

FIG. 7B is a section view along plane AA of the appliance of FIG. 7A showing two magnetocaloric elements in a first position, and

FIG. 7C is a section view along plane AA of the appliance of FIG. 7A showing two magnetocaloric elements in a second position.

### ILLUSTRATIONS OF THE INVENTION

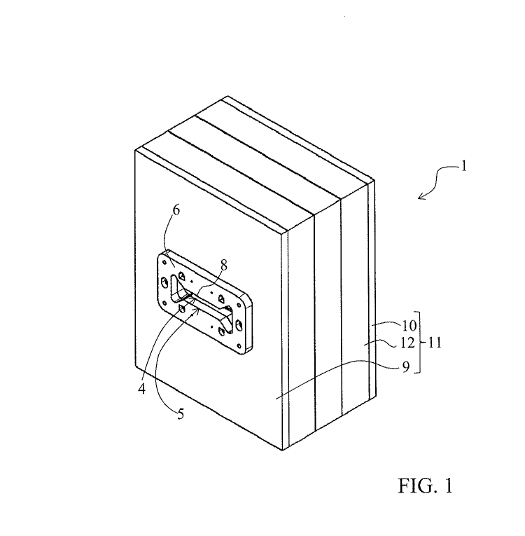

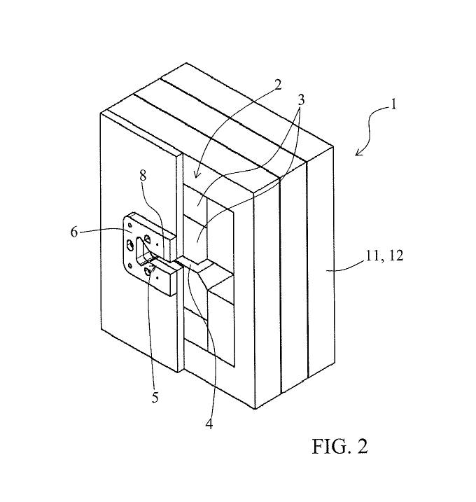

FIGS. 1 and 2 represent an embodiment of a magnetic field generator 1 intended for the magnetocaloric heat appliance according to the invention. The generator 1 comprises a magnetic assembly 2 made for example of permanents magnets 3 or of any other equivalent means, such as for example an electromagnet, defining an axial through gap 4.

This magnetic assembly 2 is housed in a casing 11 intended for closing the generated magnetic field lines. Said casing 11 comprises a peripheral envelope 12 closed by a front cover 9 and a rear cover 10. The closed peripheral envelope is preferably made out of a ferromagnetic material, while the front cover 9 and the rear cover 10 are preferably made of a magnetically non-conductive or very weakly conductive material.

The front cover 9 and the rear cover 10 comprise each an opening 5 arranged opposite to the gap 4 of the magnetic assembly 2 and putting in communication this gap 4 with the outside environment of the generator 1. This opening 5, which corresponds to the opening of the generator 1 towards the outside environment, can also be considered as being the opening 5 of the gap 4. The gap 4 is thus accessible from outside the generator 1 to receive statically or dynamically a device such as for example a magnetocaloric element to be subjected to the magnetic field present in the gap 4.

Advantageously, and according to the invention, the generator 1 comprises a means 6 able to canalise the magnetic field lines that appear outside of said generator 1, in particular in the region adjacent to the opening 5, and that generate magnetic field leakages. This canalising means 6 allows capturing or intercepting the magnetic field lines so as to direct them or to lead them towards the casing 11, so that the magnetic field will be equal to zero in the region adjacent to the opening 5 and outside of the magnetic field generator.

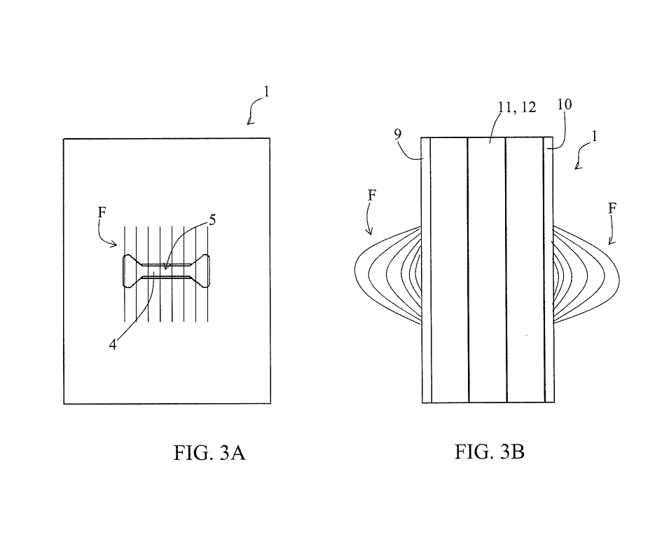

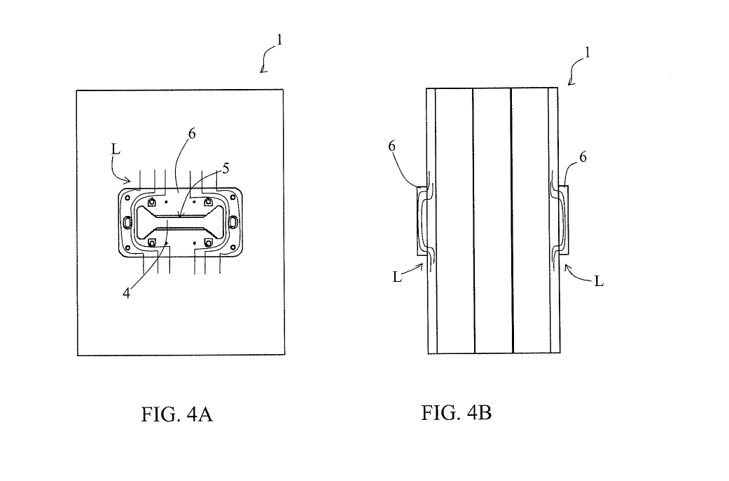

The operation and the advantages procured by said canalising means 6 appear in FIGS. 3A, 3B and 4A, 4B representing the magnetic field lines of the generator 1 respectively with and without the canalising means 6.

On FIGS. 3A and 3B, one notes the presence of magnetic field lines leakages F in the outside environment of the generator 1 close to the opening 5 of the gap 4 when the canalising means 6 is absent.

On FIGS. 4A and 4B, the magnetic field lines L in the outside environment of the generator 1 close to the opening 5 of the gap 4 are captured and guided by the canalising means 6 to avoid the opening 5 so that the generator 1 produces no field leakage F. This way, a device that is to be subjected to the magnetic field present in the gap 4 will only be subjected to this magnetic field once it will really be located inside of the gap 4, and will not be subjected to any residual magnetic field or magnetic field leakage in the outside environment close to the opening 5 of the gap 4

The canalising means 6 of the generator 1 as it is represented has the shape of an approximately rectangular plate and is made out of a ferromagnetic material. It defines a passage opening 8 superimposed on the opening 5 so as to allow the introduction of a device in the gap 4. The passage opening 8 has preferably a shape and dimensions that correspond with those of the opening 5 of the gap 4, and that are complementary with those of the device intended to move inside of the gap 4. This plate 6 is mounted on the front cover 9 and on the rear cover 10 of the generator 1 by means of screwing or by any other equivalent means. Of course, the invention is not linked with this type of configuration, any other shape of the canalising means 6 that allows canalising the magnetic field leakages can be considered and integrated in a magnetocaloric heat appliance, for example a plate having a circular shape.

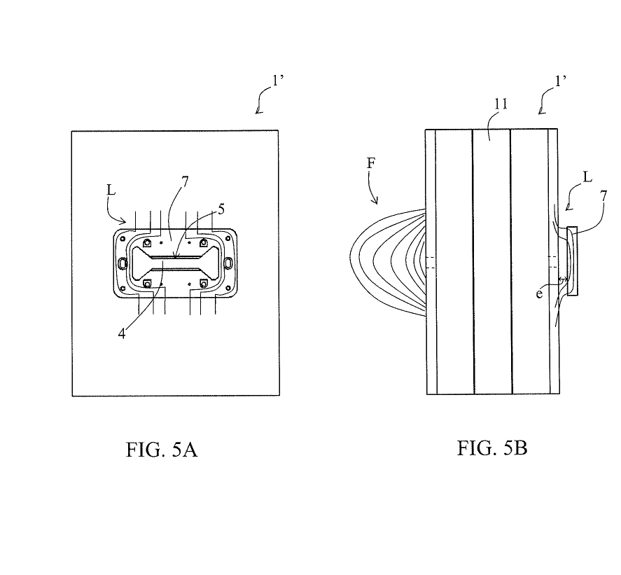

FIGS. 5A and 5B illustrate to that purpose a magnetic field generator 1′ different from the generator 1 of FIGS. 1 and 2 by the fact that its canalising means 7 is mounted on the casing 11 by means of an armature (not represented) allowing to create a space “e” between said casing 11 and said means 7; this space may be included between some millimetres and some centimetres. This variant is interesting since it has the additional advantage that it has no influence on the intensity of the magnetic field present in the gap 4 close to the opening 5 and thus that it guarantees a uniform magnetic field over the whole length of the gap 4.

In this implementation example, the parts or sections identical to that of the magnetic field generator 1 represented on FIGS. 1 and 2 have the same numerical references.

For a better understanding, this generator 1′ is represented with only one canalising means 7. It is of course obvious that, in order to avoid the magnetic field leakages at both openings 5 of the gap 4, a canalising means 7 must be mounted at each opening 5, on both sides of the gap 4.

FIGS. 5A and 5B also represent the magnetic field lines L and the magnetic field leakages F present in the outside environment of the generator 1′ close to the openings 5 of the gap 4. One notes that, on the side of the generator 1′ equipped with the canalising means 7 (right side on FIG. 5B), the field lines L are guided and directed towards the casing 11. On the other hand, on the opposite side, which is not equipped with the canalising means 7, a magnetic leakage field F appears and extends widely, in an uncontrolled way, outside of the generator 1′.

It has been noted that, for a magnetic field of 1.6 teslas in the gap 4, the magnetic leakage field measured at a distance of 30 millimetres from the gap 4, outside of the generator 1′, is 0.3 tesla on the side without canalising means 7 and 0.0018 tesla on the opposite side, equipped with the canalising means 7. Furthermore, in order to measure a field of 0.0018 tesla outside of the generator 1′ on the side without canalising means 7, one must move away by more than 100 mm from the gap 4.

The same low magnetic leakage field intensity has been measured on the variant in which the canalising means 6 is mounted directly on the casing 11 without the space “e”.

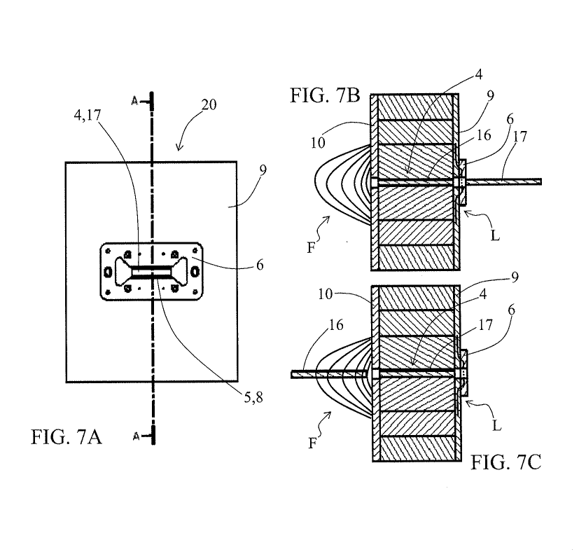

The magnetocaloric heat appliance 20 subject of the invention and represented in FIGS. 7A to 7C can be integrated in a magnetic field generator 1, 1′ represented in particular in one of FIGS. 1 to 5 and equipped with canalising means 6, 7 able to canalise the magnetic field leakages.

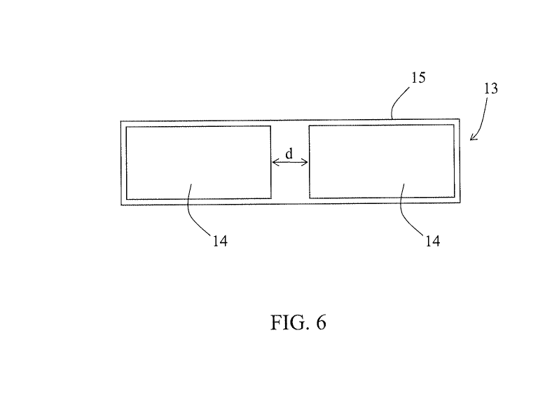

In this appliance 20, the device intended for being subjected to the magnetic field of the gap 4 is at least one magnetocaloric element 13 comprising one or several magnetocaloric materials 1, 16, 17 through which a heat transfer fluid is flowing. Said magnetocaloric element is moved through the gap 4, enters and exits it in order to be alternately magnetically activated and deactivated, so as to create alternately a heating cycle and a cooling cycle. To that purpose, said magnetocaloric element 13 can be mounted on a carriage 15 mobile transversally such as that represented in FIG. 6, or on any other suitable means.

For a better understanding, the magnetocaloric heat appliance 20 is represented with a magnetic field generator that comprises only one canalising means 6. Likewise, the means allowing to move the magnetocaloric elements and the heat transfer fluid are not illustrated. The operation of such an appliance consists in subjecting magnetocaloric elements to a magnetic field variation while putting them in contact with a heat transfer fluid that circulates in a first direction through or along the magnetocaloric elements during the increase of the magnetic field in these magnetocaloric elements and in the opposite direction during a decrease of this magnetic field. This appliance is intended to be linked thermically with one or several applications.

To that purpose, FIGS. 7B and 7C represent the two end positions possible for two magnetocaloric materials 16 and 17 with respect to an appliance 20 in order to be subjected to a magnetic cycle including a magnetization (presence in the gap 4) and a demagnetization (outside of the gap, with a magnetic field equal to zero).

As already stated, and for a better understanding, this appliance 20 is represented with only one canalising means 6 fastened to the front cover 9. It is of course obvious that, in order to avoid the magnetic field leakages at both openings 5 in communication with the gap 4, a canalising means 6 must be mounted on each opening 5, on both sides of the gap 4.

FIGS. 7B and 7C represent the magnetic field lines L and the magnetic field leakages F present in the outside environment of the appliance, close to the openings 5 in communication with the gap 4. On the outside of the appliance equipped with the canalising means 6 (right side on FIG. 7B), the field lines L are guided and directed towards the casing 11. The magnetic field is equal to zero. So, when the magnetocaloric material 17 is located in this zone (see FIG. 7B), it is subjected to a magnetic field equal to zero. This magnetocaloric material 17 undergoes a maximal magnetic field variation between its two end positions outside and inside of the gap 4. On the other hand, on the opposite outside, which has no canalising means 6, a magnetic leakage field F appears, which extends outside of the appliance and subjects the magnetocaloric material 16 to an important and uncontrolled non-zero magnetic field (see FIG. 7C). This magnetocaloric material 16 thus undergoes a reduced magnetic field variation between its two end positions outside and inside of the gap 4, because of the presence of a magnetic leakage field materialised by the field lines F, so that the magnetocaloric effect inherent to this material 16 (located on the left on FIGS. 7B and 7C) is lower than the magnetocaloric effect inherent to the other material 17 (located on the right on FIGS. 7B and 7C).

The presence of a canalising means 6, 7 around the two openings 5 in communication with the gap 4 allows achieving a sharp and maximum difference of magnetic field intensity between the inside zone and the outside zone located on both sides of the opening 5 of the gap 4. In the outside zone close to the gap 4, the magnetic field is equal or almost equal to zero, because it is canalised by the canalising means 6. The magnetic field difference between the above-mentioned zones is thus increased, which allows optimising the efficiency of the magnetocaloric heat appliance 20.

As an example, in a magnetocaloric heat appliance 20 comprising a generator 1′, 1 described above, the magnetic field difference between the outside close to the gap 4 and the gap 4 is equal to 1.6-0.3=1.3 teslas when there is no canalising means 6, 7, while it is equal to (rounded up to the hundredth) 1.6-0.0018=1.6 teslas in presence of the canalising means 6, 7. Now, the higher the magnetic field difference, the higher the magnetocaloric effect in the magnetocaloric materials 14. This implies that the use of a magnetic field generator 1, 1′ in a magnetocaloric heat appliance according to the invention allows improving the efficacy and the efficiency of the latter.

Without the presence of the canalising means 6, 7 and in order to subject a device (magnetocaloric element 13 for example) to a magnetic field difference of 1.6 teslas, it would be necessary to move this device more than 100 millimetres away from the generator 1, 1′. Now, in the case of the concerned magnetocaloric application, this movement would require high mechanical efforts due to the permeability of the magnetocaloric material. The additional energy to be supplied would therefore reduce the efficiency of the magnetocaloric heat appliance 20.

Furthermore, the integration of a magnetic field generator 1′ such as that represented in FIGS. 5A and 5B equipped with canalising means 7 at both openings 5 of the gap 4 is particularly advantageous when the magnetocaloric element 13 is made of two magnetocaloric materials 14 arranged on a carriage 15 intended for running inside of the gap 4 (see FIG. 6). These two magnetocaloric materials 14 are located at a distance “d” from each other approximately equal to the space “e” between the canalising means 7 and the opening 5. This way, when one of the magnetocaloric materials 14 is located inside of the gap 4 (the length of the gap 4 is equal to that of a magnetocaloric material 14), in an intense magnetic field, the other magnetocaloric material 14 is located outside of the gap 4 and subjected to a very weak or even zero field (of the order of 0.0018 tesla), and vice-versa when the carriage 15 moves in the opposite direction. The magnetic field difference undergone by each magnetocaloric material 14 is maximal and the efficiency of the magnetocaloric heat appliance is optimised.

The magnetocaloric heat appliance 20 according to the invention allows avoiding the presence of magnetic field leakages outside of the gap of its magnetic generator in the environment close to the opening of said gap, so that the magnetic field difference undergone by each magnetocaloric material during the magnetic cycle is made maximal.

The absence of magnetic field leakages allows meeting the requirements of the various electromagnetic regulations in force.

Consequently, the efficiency of such a magnetocaloric heat appliance is higher than that of the known appliances.

### POSSIBILITIES FOR INDUSTRIAL APPLICATION

This description shows clearly that the invention allows reaching the goals defined, that is to say to offer a magnetocaloric heat appliance whose efficiency is optimised thanks to the achievement of a higher magnetic field difference between the outside zone close to the gap 4 and the gap 4 of the magnetic field generator 1, 1′ (corresponding to the gap of the magnetocaloric heat appliance) obtained by suppressing the magnetic field leakages.

This magnetocaloric heat appliance can find an application in the area of heating, air conditioning, tempering, cooling or others, at competitive costs and with reduced space requirements.

The present invention is not restricted to the examples of embodiment described, but extends to any modification or variant which is obvious to a person skilled in the art while remaining within the scope of the protection defined in the attached claims.

1-7. (canceled)

8. A magnetocaloric heat appliance comprising:
at least one magnetocaloric element (13) through which a heat transfer fluid flows,
a means of magnetic activation and deactivation of the magnetocaloric element comprising a magnetic field generator (1, 1′) provided with at least one magnetic assembly (2) arranged so as to create a magnetic field in a gap (4), and
the magnetocaloric element (13) being in a relative movement with respect to the magnetic field generator (1, 1′), appliance
wherein the magnetic assembly (2) is arranged in a casing (11) which comprises at least one opening (5) that is in communication with the gap (4) and the magnetic field generator (1, 1′) also comprises at least one canalising means (6, 7) connected with the casing (11) and able to capture and canalise the magnetic field leakages that appear outside of the magnetic field generator (1, 1′), in a region close to the opening (5).

9. The appliance according to claim 8, wherein the magnetocaloric element (13) circulates alternately towards a first end of the appliance and towards a second end, opposite to the first end, in order to circulate alternately inside and outside of the gap (4) of the magnetic field generator (1, 1′).

10. The appliance according to claim 8, wherein the canalising means (6, 7) comprises a part made of a ferromagnetic material arranged around the opening and delimiting a passage opening (8) corresponding to the opening (5) of gap (4).

11. The appliance according to claim 10, wherein the canalising means (6) is mounted on the housing (11) in direct contact with the housing (11).

12. The appliance according to claim 10, wherein the canalising means (7) is mounted on the housing (11), at a distance from the housing (11), by a mounting armature.

13. The appliance according to claim 8, wherein the canalising means (6, 7) has the shape of an approximately rectangular plate provided with a passage opening (8) whose shape and dimensions correspond with those of the magnetocaloric element (13).

14. The appliance according to claim 8, wherein the canalising means has the shape of an approximately circular plate provided with a passage opening (8) whose shape and dimensions correspond with those of the magnetocaloric element (13).
